(19) United States
(12) Patent Application Publication
(10) Pub. No.: US 2016/0269795 A1
(43) Pub. Date: Sep. 15, 2016

(54) INSTRUCTING MODE SWITCHING METHOD AND DEVICE BASED ON SMART TELEVISION INTERFACE

(71) Applicant: LE SHI ZHI XIN ELECTRONIC TECHNOLOGY (TIANJIN) LIMITED, China (CN)

(72) Inventors: Shangliang CI, Beijing (CN); Jia LIU, Beijing (CN); Fan LIANG, Beijing (CN)

(21) Appl. No.: 15/033,068

(22) PCT Filed: Oct. 22, 2014
(86) PCT No.: PCT/CN2014/089200

§ 371 Date: Apr. 28, 2016

(30) Foreign Application Priority Data
Oct. 30, 2013 (CN) 201310530784.4

(51) Int. Cl. H04N 21/485; G06F 3/0481

(52) U.S. Cl. CPC H04N 21/4858; G06F 3/04812

(57) ABSTRACT

A method and instruction mode switching device based on the smart television interface, comprising: receiving a requesting information to switch the current smart television interface to a target interface, analyzing said requesting information to obtain the target interface requested to switch and acquiring the operating mode matching said target interface as per the correspondence between said target interface and the preset operating mode, switching the smart television to said target interface and executing the operation of said target interface by means of said operating mode. With this method, the specific target interface is based on to acquire and switch to the operating mode matching said target interface. The matching operating mode is preset and adapts to the user habit of operating different interfaces, so it conforms to the operating habits of users and hence improves the user experience.

The present disclosure is a national stage of International Application No. PCT/CN2014/089200, filed Oct. 22, 2014, which claims the priority to China patent application submitted to China Patent Office on Oct. 30, 2013 with the application number of 201310530784.4 and the title of “Instructing mode switching method and apparatus based on smart television interface”, the entire contents of all of which are incorporated herein by reference.

### FIELD OF TECHNOLOGY

The present disclosure generally relates to the field of a smart television, especially an instructing mode switching method and device based on smart television interface.

### BACKGROUND

The television is the most common household appliance in modern society. As the development of science and technology, the smart television installed with a fully-open platform and operating system has emerged at a right moment. A user can use a smart television to enjoy the ordinary television contents and also install and download various application software by oneself. The functionalities of a smart television can be expanded and updated continuously to bring a rich personalized experience for users.

Until now, the smart television has been operated by means of focus mode or air mouse mode. The focus mode is an operating mode to display on the screen of a smart television in the form of focus frame where a remote control is used to press the keys Up, Down, Left or Right to adjust the position of the focus frame on the interface so as to move the focus frame to a target position. The air mouse mode is an operating mode to display on the screen of smart television in the form of a pointer where a user can click a direction key once to move the pointer on the television screen by corresponding preset distance in this direction.

The smart television is designed with several interfaces available to switch and operate. Nevertheless, the setting of current smart televisions can only allow the same operating mode for various interfaces of smart television. Hence, there is only single operating mode in the smart televisions resulting in poor user experience.

### SUMMARY

In consideration of those, one of the purposes of the present disclosure is to provide a method and instruction mode switching device based on smart television interface that can allow to select the operating mode matching an interface to realize good user experience.

An instruction mode switching method based on mart television interface, including:
receiving a requesting information to switch the current smart television interface to a target interface,
analyzing said requesting information to obtain the target interface requested to switch and acquire the operating mode matching said target interface as per the correspondence between said target interface and the preset operating mode,
switching the smart television to said target interface and execute the operation of said target interface by means of said operating mode.

In the method above, according to an embodiment of the present disclosure, said correspondence between said target interface and the preset operating modes is:
if said target interface is a tabbed interface, said preset operating mode is a focus mode, said tabbed interface is an interface which comprises and displays at least one tab,
if said target interface is a web interface, said preset operating mode is air mouse mode.

In the method above, according to an embodiment of the present disclosure, said “receiving a requesting information to switch the current smart television interface to a target interface” comprises:
if said target interface is a tabbed interface, said tabbed interface is an interface generated through triggering a tab button preset in the search bar on the browser interface of said smart television,
when said tab button is triggered, the requesting information to switch the current smart television interface to said tab interface is received.

In the method above, according to an embodiment of the present disclosure, said “switching the smart television to said target interface and execute the operation of said target interface by means of said operating mode” includes:
when said target interface is a tabbed interface, the preset operating mode matching said tabbed interface is focus mode, said smart television interface is switched to said tabbed interface and the individual tab and the focus frame on said tabbed interface is displayed,
the command of switching to focus mode is generated and the mode-switching interface of remote control is called to send said command of switching to focus mode to the remote control so as to control said focus frame to move among said various tabs by said remote control and display the brief information of tabs.

In the method above, according to an embodiment of the present disclosure, it also comprises:
when said focus frame is moved among said various tabs, said tab selected is dragged to the position of visual focus.

In the method above, according to an embodiment of the present disclosure, if said tabbed interface is the interface generated through triggering the tab button preset in the search bar on the browser interface and said tab is the tab selected by the focus frame, the brief information of the tab displayed comprises the thumbnail of said tab, the name of web page corresponding to said tab and the web site corresponding to said tab,
if said tab is the tab selected by the focus frame, the brief information of the tab displayed comprises: the thumbnail of said tab.

In the method above, according to an embodiment of the present disclosure, said “switching the smart television to said target interface and execute the operation of said target interface by means of said operating mode” includes:
if said target interface is a web interface, the preset operating mode matching said web interface is air mouse mode, said smart television interface is switched to said web interface and the contents of a web page and the mouse pointer on said web interface is displayed,
the command of switching to air mouse mode is generated and the mode-switching interface of remote control is called to send said command of switching to air mouse mode to the remote control so as to control said mouse pointer to move by said remote control.

An instruction mode switching device based on smart television interface that includes:
receiving module configured to receive a requesting information to switch the current smart television interface to a target interface,
analysis module configured to analyze said requesting information to obtain the target interface requested to switch and acquire the operating mode matching said target interface as per the correspondence between said target interface and the preset operating mode,
switching module configured to switch the smart television to said target interface and execute the operation of said target interface by means of said operating mode.

In the device above, according to an embodiment of the present disclosure, if said target interface is a tabbed interface, the preset operating mode matching said tabbed interface is focus mode and said switching module includes:
a first switching module configured to switch said smart television interface to said tabbed interface,
a first command generating module configured to generate a command of switching to focus mode,
a first sending module configured to call the mode-switching interface of remote control to send said command of switching to focus mode to the remote control so as to control said focus frame to move among said various tabs by said remote control,
a first display module configured to display various tabs and focus frame of said tabbed interface and the brief information of said tab.

In the device above, according to an embodiment of the present disclosure, if said target interface is a web interface, the preset operating mode matching said tabbed interface is air mouse mode, and said switching module includes:
a second switching module configured to switch said smart television interface to said web interface,
a second command generating module configured to generate a command of switching to air mouse mode,
a second sending module configured to call the mode-switching interface of remote control to send said command of switching to air mouse mode to the remote control so as to control said mouse pointer to move by said remote control,
a second display module configured to display the contents of web page and the mouse pointer of said web interface.

A non-transitory computer readable recording medium having computer programs stored thereon that, when executed by one or more processors of an electronic apparatus, cause the electronic apparatus to perform:
receiving a requesting information to switch the current smart television interface to a target interface,
analyzing said requesting information to obtain the target interface requested to switch and acquiring the operating mode matching said target interface as per the correspondence between said target interface and the preset operating mode,
switching the smart television to said target interface and executing the operation of said target interface by means of said operating mode.

There is further provided a smart television based on a smart television interface, characterized in that, the smart television includes:
a memory having instructions stored thereon;
a processor configured to execute the instructions to perform operations, comprising:
receiving a requesting information to switch the current smart television interface to a target interface,
analyzing said requesting information to obtain the target interface requested to switch and acquire the operating mode matching said target interface as per the correspondence between said target interface and the preset operating mode,
switching the smart television to said target interface and execute the operation of said target interface by means of said operating mode.

The present disclosure provides an instruction mode switching method based on a smart television interface which includes receiving a requesting information to switch the current smart television interface to a target interface, analyzing said requesting information to obtain the target interface requested to switch and acquire the operating mode matching said target interface as per the correspondence between said target interface and the preset operating mode, switching the smart television to said target interface and execute the operation of said target interface by means of said operating mode. With this method, a specific target interface is based on to acquire and switch to the operating mode matching said target interface. The matching operating mode is preset and adapts to the user habit of operating different interfaces, so conforms to the operating habits of users and hence improves user experience.

### BRIEF DESCRIPTION OF THE DRAWING

In order to illustrate technical solutions in the present disclosure more clearly, hereinafter, the Figures which need to be used in describing the embodiments hereinbelow are introduced briefly. Obviously, the Figures described hereinbelow are only some embodiments of the present disclosure, a skilled person in the art may obtain other Figures according to these Figures below without creativity.

FIG. 1 is the flow chart of one embodiment of the instruction mode switching method based on smart television interface according to the present disclosure.

FIG. 2 is the flow chart of another embodiment of the instruction mode switching method based on smart television interface according to the present disclosure.

FIG. 3 is the flow chart of one more embodiment of the instruction mode switching method based on smart television interface according to the present disclosure.

FIG. 4 is the structural diagram of one embodiment of the instruction mode switching device based on smart television interface according to the present disclosure.

FIG. 5 is the structural diagram of another embodiment of the instruction mode switching device based on a smart television interface according to the present disclosure.

FIG. 6 is the structural diagram of one more embodiment of the instruction mode switching device based on a smart television interface according to the present disclosure.

FIG. 7 is the flow chart of one application scenario of the instruction mode switching method based on smart television interface according to the present disclosure.

FIG. 8 is the schematic diagram of the browser interface of smart television in one application scenario of the instruction mode switching method based on smart television interface according to the present disclosure.

FIG. 9 is the schematic diagram of the tabbed interface in one application scenario of the instruction mode switching method based on smart television interface according to the present disclosure.

FIG. 10 is a flow chart of one application scenario of the instruction mode switching method based on smart television interface according to the present disclosure.

FIG. 11 is a schematic diagram of the tabbed interface in one application scenario of the instruction mode switching method based on smart television interface according to the present disclosure.

FIG. 12 is a schematic diagram of the tabbed interface in one application scenario of the instruction mode switching method based on smart television interface according to the present disclosure.

FIG. 13 is a schematic diagram of the tabbed interface in one application scenario of the instruction mode switching method based on smart television interface according to the present disclosure.

FIG. 14 is the flow chart of another application scenario of the instruction mode switching method based on smart television interface according to the present disclosure.

FIG. 15 is the schematic diagram of the web interface in another application scenario of the instruction mode switching method based on a smart television interface according to the present disclosure.

### DESCRIPTION OF THE EMBODIMENTS

In order to make the objective, technical solution and advantages of the embodiment of the present disclosure more clear, hereinafter, the technical solution in the embodiment of the present disclosure is illustrated clearly and completely with the accompanying drawings in the embodiment of the present disclosure. Based on the embodiment of the present disclosure, a skilled person in the art may obtain all the other embodiments without creativity, which are all in the scope of the present disclosure.

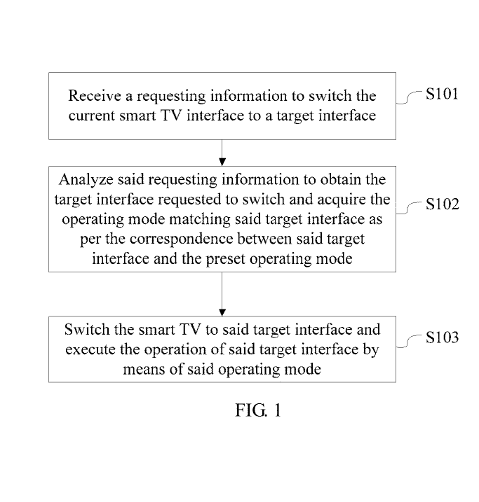

FIG. 1 shows the flow chart of an instruction mode switching method based on smart television interface provided by one embodiment according to the present disclosure that includes:

Step S101: receiving requesting information to switch the current smart television interface to a target interface,

if a user requests to switch the interface of smart television, the requesting information to switch the current smart television interface to a target interface is received. A user can use a control device such as remote control or a corresponding equipment or device installed in smart television to request switching which generates the requesting information.

Step S102: analyzing said requesting information to obtain the target interface requested to switch and acquire the operating mode matching said target interface as per the correspondence between said target interface and the preset operating mode,

the requesting information can include: various information related to switching such as the time of generating the requesting information, the target interface requested, the preset switching time.

A correspondence is preset between the interface and the operating mode where each interface has the corresponding preset operating mode matching this interface. For one known interface, the correspondence can be based to get the operating mode matching the interface.

For example, if this target interface is a tabbed interface, said preset operating mode is a focus mode. If said target interface is a web interface, said preset operating mode is an air mouse mode. Or, if said target interface is an interface of television broadcasting, said preset operating mode is a focus mode. If said target interface is a document management interface, said preset operating mode is an air mouse mode. The specific correspondence can be set up by the user as per user operating habit during actual practice and will not be repeated here.

This tabbed interface is an interface that includes and displays at least one tab wherein any of the tabs is used to mark the classification or content of the corresponding target.

Analyzing this requesting information to obtain the target interface requested to switch as per the correspondence with this target interface can produce and acquire the operating mode matching the target interface.

Step S103: switching the smart television to said target interface and executing the operation of said target interface by means of said operating mode.

As per the acquired target interface requested to switch, the smart television is switched to the target interface. As well, the acquired operating mode is used to operate in the target interface after switched.

The correspondence is the condition to bind an interface with an operating mode. Any interface involved in such correspondence has a bound operating mode. Different operating modes can be set for different target interfaces as per user habits so as to improve user experience.

In conclusion, this embodiment provides an instruction mode switching method based on a smart television interface which includes receiving a requesting information to switch the current smart television interface to a target interface, analyzing said requesting information to obtain the target interface requested to switch and acquire the operating mode matching said target interface as per the correspondence between said target interface and the preset operating mode, switching the smart television to said target interface and execute the operation of said target interface by means of said operating mode. With this method, a specific target interface is based on to acquire and switch to the operating mode matching said target interface. The matching operating mode is preset and adapts to the user habit of operating different interfaces, so conforms to the operating habits of users and hence improves the user experience.

A tab button is preset in the browser search bar of smart television, the tab button is triggered to generate a tabbed interface, then said target interface is the tabbed interface that includes and displays at least one tab.

Now, the requesting information is generated upon triggering said tab button and the content of information is switching the current smart television interface to the tabbed interface.

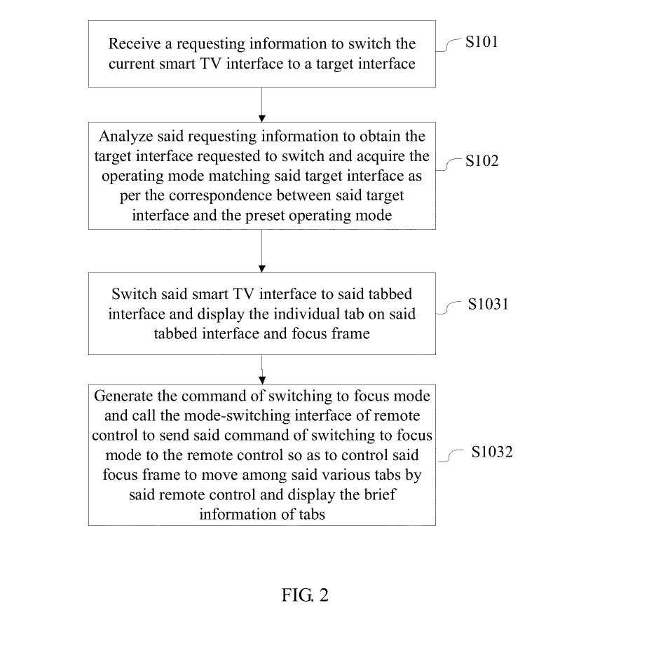

FIG. 2 shows the flow chart of the instruction mode switching method based on smart television interface provided by another embodiment according to the present disclosure where Step S103 includes specifically in the flow chart shown in FIG. 1:

Step S1031: switching said smart television interface to said tabbed interface and display the individual tab and the focus frame of said tabbed interface,

if said target interface is a tabbed interface, the current smart television interface is switched to the tabbed interface, and the individual tab and the focus frame used to indicate selection of said tabbed interface is displayed on the screen of said smart television.

Step S1032: the command of switching to focus mode is generated and the mode-switching interface of remote control is called to send said command of switching to focus mode to the remote control so as to control said focus frame to move among said various tabs by said remote control and display the brief information of tabs.

During the course of switching smart television interface, the operating mode of smart television is also switched to the focus mode matching the tabbed interface.

There is a mode-switching interface of remote control specially set in smart television via which the command of switching mode of remote control can be sent to the remote control.

During actual practice, this smart television can transmit the command of switching mode of remote control to the remote control via blue tooth.

The command of switching to focus mode is generated and the mode-switching interface of remote control is called to send the command of switching to focus mode to the remote control and switch the operating mode, so as to move the focus frame among said various tabs by said remote control and display the brief information of tabs.

The displayed brief information of the selected tab includes: the thumbnail of the tab, the name of web page corresponding to said tab and the web site corresponding to said tab, the displayed brief information of unselected tab includes: the thumbnail of the tabs.

When any tab is selected by the focus frame, in order to highlight the selected tab, the selected tab can be moved to the position of visual focus such as the central position of smart television once the focus frame is moved onto the tab or the tab can show an expanded size or a changed color once the focus frame is moved onto the tab. When the focus frame is moved to other tab, this tab restores the original shape.

In this embodiment, the displayed information of the selected tab includes: the thumbnail of this tab, the name of the web page corresponding to said tab and the web site corresponding to said tab. But the information is not limited to the above and in actual practice, can also include other information used to mark the tab.

In conclusion, this embodiment provides an instruction mode switching method based on smart television interface. If said target interface is a tabbed interface including and displaying at least one tab, said smart television interface is switched to said tabbed interface and the individual tab and the focus frame of said tabbed interface is displayed. The command of switching to focus mode is generated and the mode-switching interface of remote control is called to send said command of switching to focus mode to the remote control so as to move said focus frame among various said tabs by said remote control and display the brief information of tabs. The operating mode in this tab interface is switched to focus mode and the appropriate user can select and control various tabs displayed in the tabbed interface to adapt to the operating habit of user and hence improve user experience.

In another embodiment according to the present disclosure, the target interface is a web interface and the preset operating mode matching said web interface is air mouse mode.

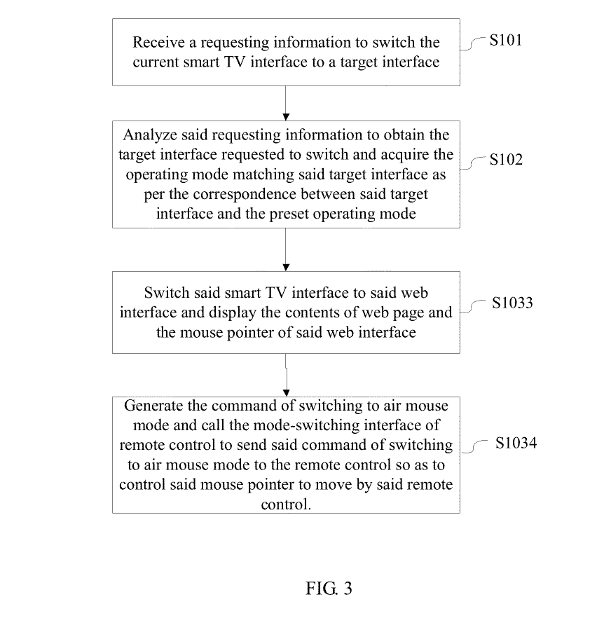

FIG. 3 shows the flow chart of the instruction mode switching method based on smart television interface provided by this embodiment according to the present disclosure where Step S103 includes specifically in the flow chart shown in FIG. 1:

Step S1033: switching said smart television interface to said web interface and display the contents of a web page on said web interface and mouse pointer.
if said target interface is a web interface, the current smart television interface is switched to the web interface and the contents of the web interface and the most commonly used mouse pointer of the web page is displayed on the screen of said smart television.

Step S1034: generating the command of switching to air mouse mode and calling the mode-switching interface of remote control to send said command of switching to air mouse mode to the remote control so as to control said mouse pointer to move by said remote control.

Upon switching the smart television interface, the operating mode of smart television is also be switched to air mouse mode matching the web interface.

The command of switching to air mouse mode is generated and the mode-switching interface of remote control is called to send said command of switching to air mouse mode to the remote control and switch the operating mode, so as to control said mouse pointer to move on the web interface by said remote control.

In conclusion, this embodiment provides an instruction mode switching method based on smart television interface. If said target interface is a web interface, the preset operating mode matching said web interface is an air mouse mode. Said smart television interface is switched to said web interface and the contents of web page and the mouse pointer of said web interface is displayed. The command of switching to air mouse mode is generated and the mode-switching interface of remote control is called to send the command of switching the air mouse mode to the remote control so as to control said mouse pointer to move by said remote control. The operating mode in this a web interface is switched to air mouse mode and the appropriate user can use the mouse pointer to select the contents in the web interface to adapt to the user operating habit and hence improve user experience.

Corresponding to the embodiments above of the instruction mode switching method based on smart television interface according to the present disclosure, the specification of the present disclosure also provides the embodiments of the instruction mode switching device based on a smart television interface.

The present disclosure also provides a computer readable recording medium recording the program used to execute the mentioned methods.

The mentioned computer readable recording medium includes any mechanism used to store in format readable by computer or carry information. For example, the machine readable media includes read-only memory (ROM), random access memory (RAM), disc storage medium, optical storage medium, flash storage medium, electric, light, sound and other formats of transmitting signal (for example, carrier wave, infrared signal, digital signal, etc), etc.

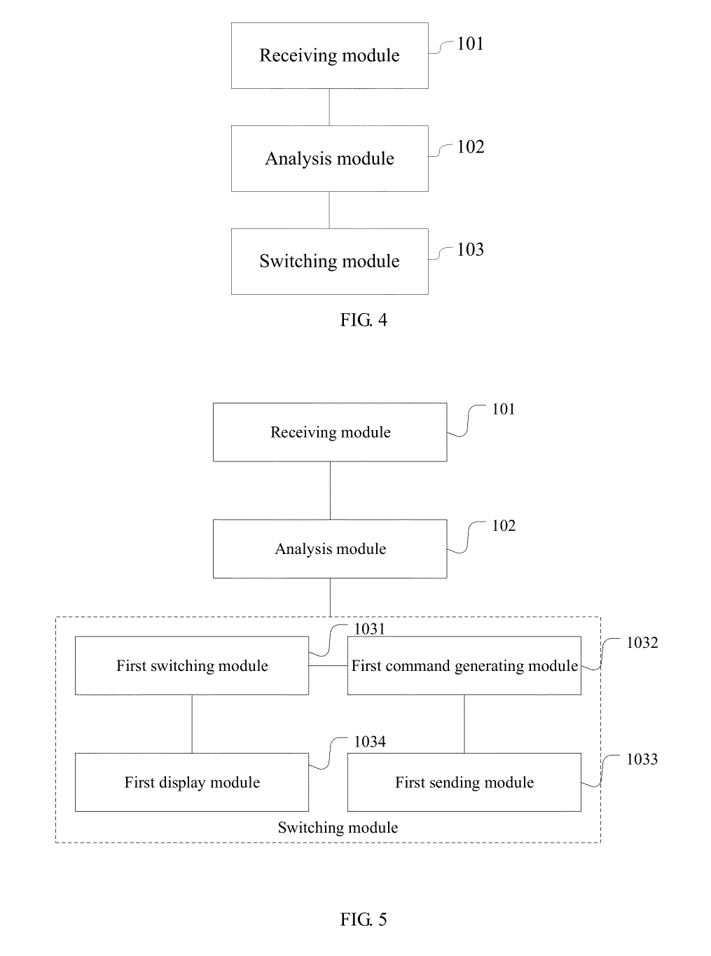

FIG. 4 shows the structural diagram of one embodiment of the instruction mode switching device based on smart television interface according to the present disclosure where said device includes: receiving module 101, analysis module 102 and switching module 103,
wherein: said receiving module 101 is configured to receive a requesting information to switch the current smart television interface to a target interface,
if a user requests to switch the interface of smart television, the receiving module 101 will receive the requesting information to switch the current smart television interface to the target interface. A user can use control device such as remote control or a corresponding equipment or device installed in smart television to request switching which will generate the requesting information,
wherein: said analysis module 102 is configured to analyze said requesting information to obtain the target interface requested to switch and acquire the operating mode matching said target interface as per the correspondence between said target interface and the preset operating mode,
the requesting information can include: various information related to switching such as the time of generating the requesting information, the target interface requested, the preset switching time.

A correspondence is preset between the interface and the operating mode where each interface has the corresponding preset operating mode matching this interface. For one known interface, the correspondence can be based to get the operating mode matching the interface.

For example, if this target interface is a tabbed interface, said preset operating mode is a focus mode. If said target interface is a web interface, said preset operating mode is an air mouse mode. Or, if said target interface is an interface of television broadcasting, said preset operating mode is a focus mode. If said target interface is document management interface, said preset operating mode is an air mouse mode. The specific correspondence can be set up by the user as per the operating habit during the practical application and will not be repeated here.

The tabbed interface is an interface that includes and displays at least one tab wherein any of the tabs is used to mark the classification or the content of the corresponding target.

The analysis module 102 analyzes this requesting information to obtain the target interface requested to switch. The target interface and the correspondence are based to produce and acquire the operating mode matching the target interface,
wherein: said switching module 103 is configured to switch the smart television to said target interface and execute the operation of said target interface by means of said operating mode.

As per the acquired target interface requested to switch, the switching module 103 switches the smart television to the target interface. As well, the acquired operating mode is used to operate in the target interface after switched.

The correspondence is the condition to bind an interface with an operating mode. Any interface involved in such correspondence has a bound operating mode. Different operating modes are set for different target interfaces as per the user habits to improve user experience.

In conclusion, this embodiment provides an instruction mode switching device based on smart television interface which includes a receiving module configured to receive a requesting information to switch the current smart television interface to a target interface, an analysis module configured to analyze said requesting information to obtain the target interface requested to switch and acquire the operating mode matching said target interface as per the correspondence between said target interface and the preset operating mode, a switching module configured to switch the smart television to said target interface and execute the operation of said target interface by means of said operating mode. With this device, a specific target interface is based on to acquire and switch to the operating mode matching said target interface. The matching operating mode is preset and adapts to the user habit of operating different interfaces, so conforms to the operating habits of users and hence improves the user experience.

A tab button is preset in the browser search bar of smart television, the tab button is triggered to generate a tabbed interface, then said target interface is a tabbed interface that includes and displays at least one tab.

Now, the requesting information is generated upon triggering said tab button and the content of information is switching the current smart television interface to the tabbed interface.

FIG. 5 shows the structural diagram of the instruction mode switching device based on smart television interface provided by another embodiment according to the present disclosure. In the structure shown in FIG. 4, the switching module 103 includes specifically: first switching module 1031, first command generating module 1032, first sending module 1033 and first display module 1034,
wherein: said first switching module 1031 is configured to switch said smart television interface to said tabbed interface,
if said target interface is a tabbed interface, first switching module 1031 will switch the current smart television interface to the tabbed interface and display the individual tab of said tabbed interface and the focus frame configured to indicate the selection state on the screen of said smart television via first display module 1034,
wherein: said first command generating module 1032 is configured to generate a command of switching to focus mode,
said first sending module 1033 is configured to call the mode-switching interface of remote control to send said command of switching to focus mode to the remote control so as to control said focus frame to move among said various tabs by said remote control,
upon switching smart television interface, the operating mode of the smart television is also switched to the focus mode matching the tabbed interface.

There is a mode-switching interface of remote control specially set in smart television via which the command of switching mode of remote control can be sent to the remote control.

During actual practice, this smart television can transmit the command of switching mode of remote control to the remote control via blue tooth.

first command generating module 1032 generates the command of switching to focus mode and first sending module 1033 calls the mode-switching interface of remote control to send the command of switching to focus mode to the remote control and switches the operating mode, so as to move the focus frame among said various tabs by said remote control and first display module 1034 displays the brief information of tabs.

The displayed brief information of the selected tab includes: the thumbnail of the tab, the name of web page corresponding to said tab and the web site corresponding to said tab; the displayed brief information of unselected tab includes: the thumbnail of the tab.

In this embodiment, the displayed information of the selected tab includes: the thumbnail of this tab, the name of web page corresponding to said tab and the web site corresponding to said tab. The information is not limited to the above and in actual practice, can also include other information used to mark the tab.

In conclusion, this embodiment provides an instruction mode switching method based on smart television interface. If said target interface is a tabbed interface, the preset operating mode matching said tabbed interface is focus mode and said switching mode includes: first switching module configured to switch said smart television interface to said tabbed interface, first command generating module configured to generate the command of switching to focus mode, first sending module configured to call the switching interface of remote control mode to send said command of switching to focus mode to the remote control so as to control said focus frame to move among said various tabs by said remote control, first display module configured to display the individual tab and the focus frame on said tab interface and the brief information of said tabs. The operating mode in this a tabbed interface is switched to focus mode and it is suitable for the users to select and control various tabs displayed in the tabbed interface to adapt to the operating habit of user and hence improve user experience.

In this embodiment, the target interface is a web interface and the preset operating mode matching said web interface is air mouse mode.

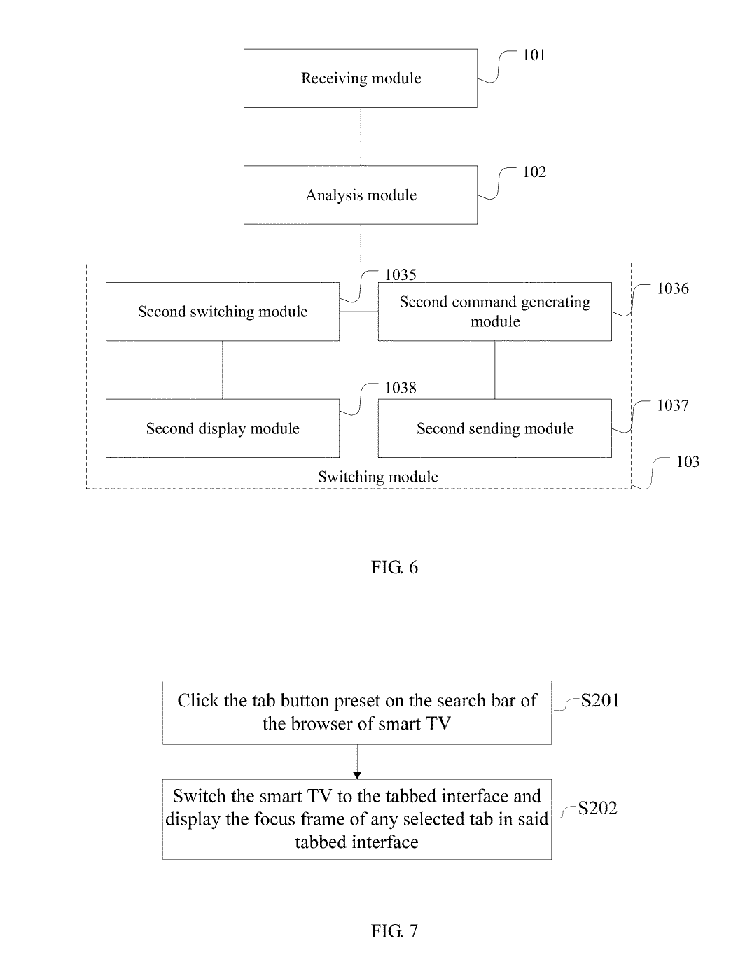

FIG. 6 shows the structural diagram of the instruction mode switching device based on a smart television interface provided by another embodiment according to the present disclosure. In the structure shown in FIG. 4, the switching module 103 includes specifically: second switching module 1035, second command generating module 1036, second sending module 1037 and second display module 1038.

If said target interface is a web interface, second switching module 1035 will switch the current smart television interface to the web interface and display the contents of the web interface and the most commonly used mouse pointer of the web page on the screen of said smart television via second display module 1038.

Upon switching smart television interface, the operating mode of a smart television is also switched to air mouse mode matching the web interface.
second command generating module 1036 generates the command of switching to air mouse mode and second sending module 1037 calls the switching interface of remote control mode to send said command of switching to air mouse mode to the remote control and switch the operating mode, so as to control said mouse pointer to move on the web interface by said remote control.

In conclusion, this embodiment provides an instruction mode switching device based on a smart television interface. If said target interface is a web interface, second switching module will switch said smart television interface to said web interface, second command generating module will generate the command of switching to air mouse mode, second sending module will call the mode-switching interface of remote control to send said command of switching to air mouse mode to the remote control so as to control said mouse pointer to move by said remote control, second display module will display the contents of web page and the mouse pointer of said web interface. The operating mode in this a web interface is switched to the air mouse mode and it is suitable for the users to use the mouse pointer to select the contents in the web interface to adapt to the operating habit of user and hence improve user experience.

The concrete structure of the switching module of one embodiment according to the present disclosure includes first switching module, first command generating module, first sending module and first display module. Nevertheless, the concrete structure of the switching module of another embodiment according to the present disclosure includes second switching module, second command generating module, second sending module and second display module, so they are different from each other. However, it is not a limitation here. In the actual practice, the same structures in the switching modules can be simplified to one that just executes the different functions as per different target interfaces.

The present disclosure provides a specific application scenario of the instruction mode switching method based on a smart television interface.

The flow chart of the application scenario is as shown in FIG. 7.

The switching in this application scenario mainly involves the switching from web interface to tabbed interface in the browser.

Step S201: clicking the tab button preset on the search bar of the browser of a smart television.

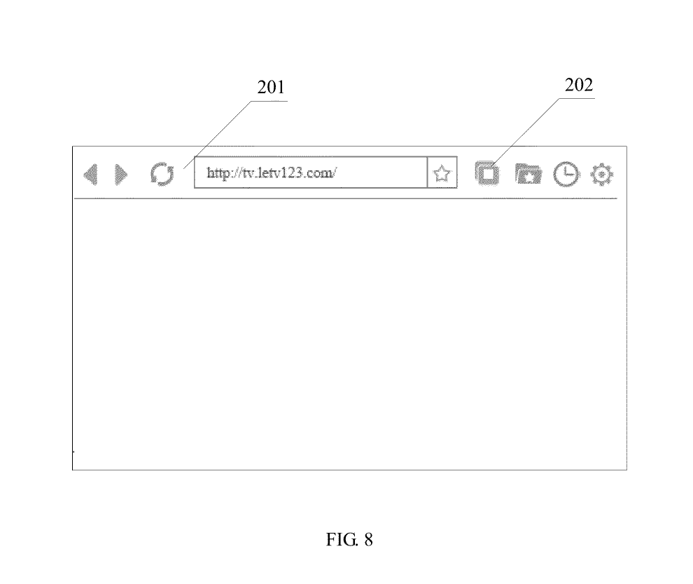

FIG. 8 shows the schematic diagram of the browser interface of a smart television where there is a tab button 202 preset on the search bar 201 of the browser of a smart television. If the tab button is triggered, the requesting information to request switching the current smart television interface to the tabbed interface is generated.

Click the tab button to generate the requesting information to request switching the current smart television interface to the tabbed interface. As per the correspondence between the tabbed interface and the preset operating mode, the operating mode matching the tabbed interface is acquired as focus mode.

Step S202: switching the smart television to the tabbed interface and displaying the focus frame of any selected tab in said tabbed interface,

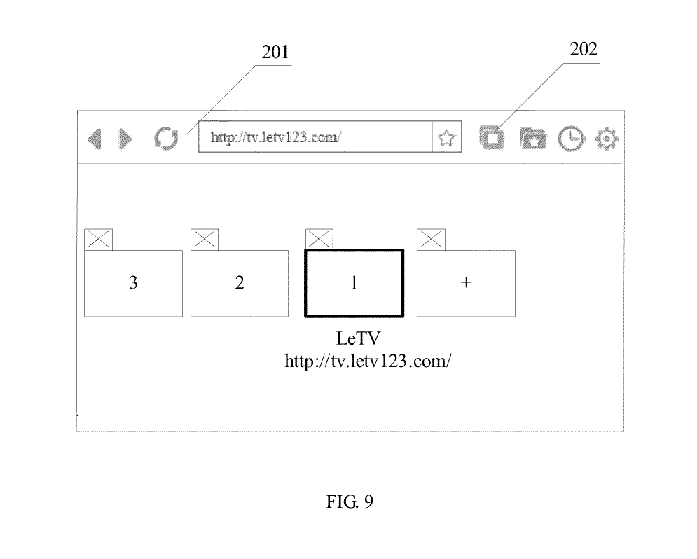

The tabbed interface produced from switching is as shown in FIG. 9 which includes three usable tabs 1, 2 and 3 as well as one newly added page tab “+”. These four tabs are arrayed in single row where the one currently selected is 1 whose thumbnail, the name of the corresponding web page “LeTV” and the web site corresponding to said tab “http://tv.letv123.com/” are shown, other three tabs are not selected whose thumbnails are only shown.

Step S201˜S202 is the process of switching to tabbed interface.

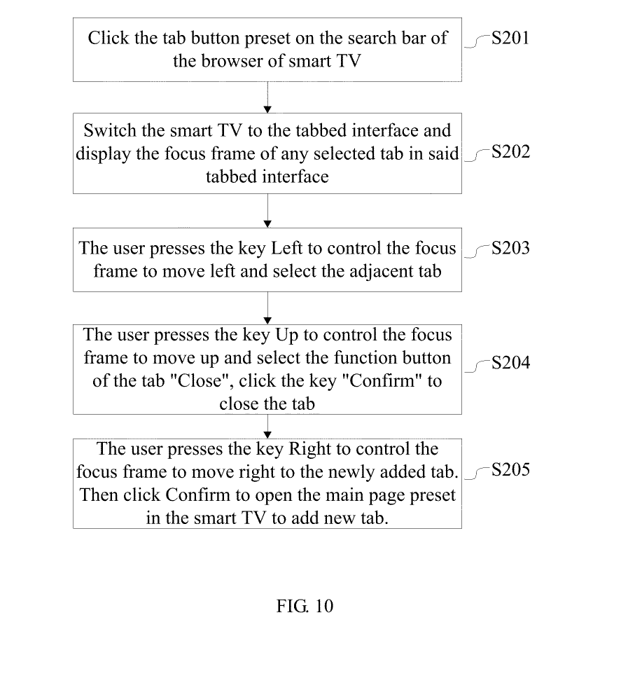

Another flow chart of the application scenario is as shown in FIG. 10.

The process to operate the tabs in the tabbed interface after entering the tabbed interface.

In this flow chart, the following steps are also included after Step S202:

Step S203: the user presses the key Left to control the focus frame to move left and select the adjacent tab.

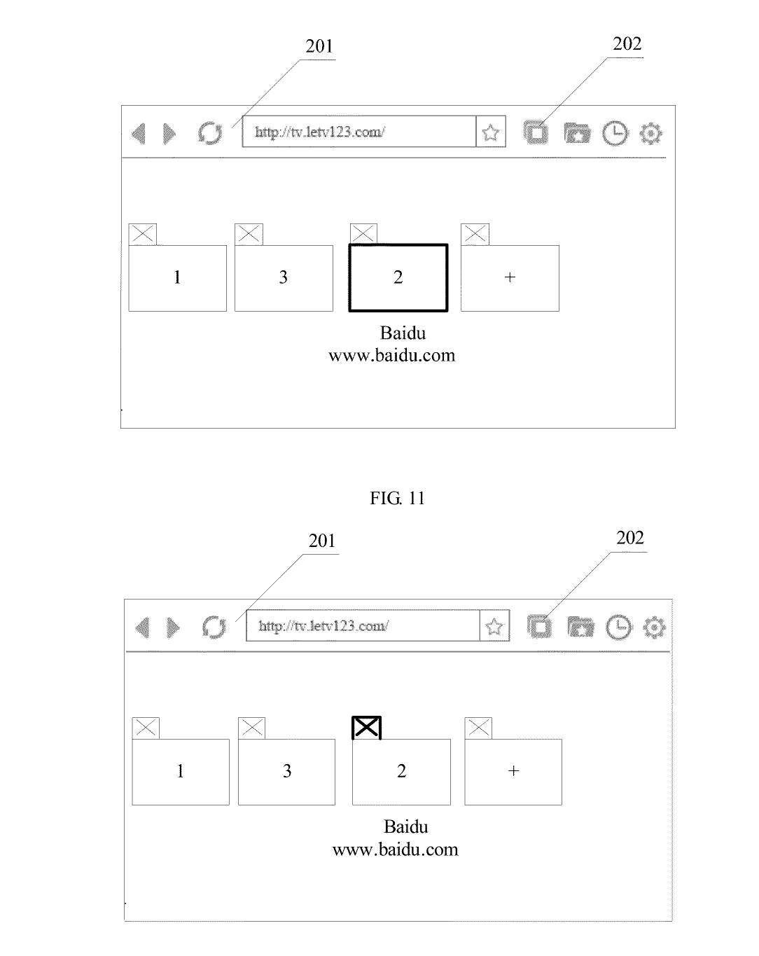

In another schematic diagram of the tabbed interface as shown in FIG. 11, the tabbed interface is one after the focus frame is moved where the one currently selected is 2 whose thumbnail, the name of “Baidu” of the corresponding web page and the web site corresponding to said tab “www.baidu.com” are shown, other three tabs are not selected whose thumbnails are only shown.

Step S204: the user presses the key Up to control the focus frame to move up and select the function button of tab “Close”, click the key “Confirm” to close the tab.

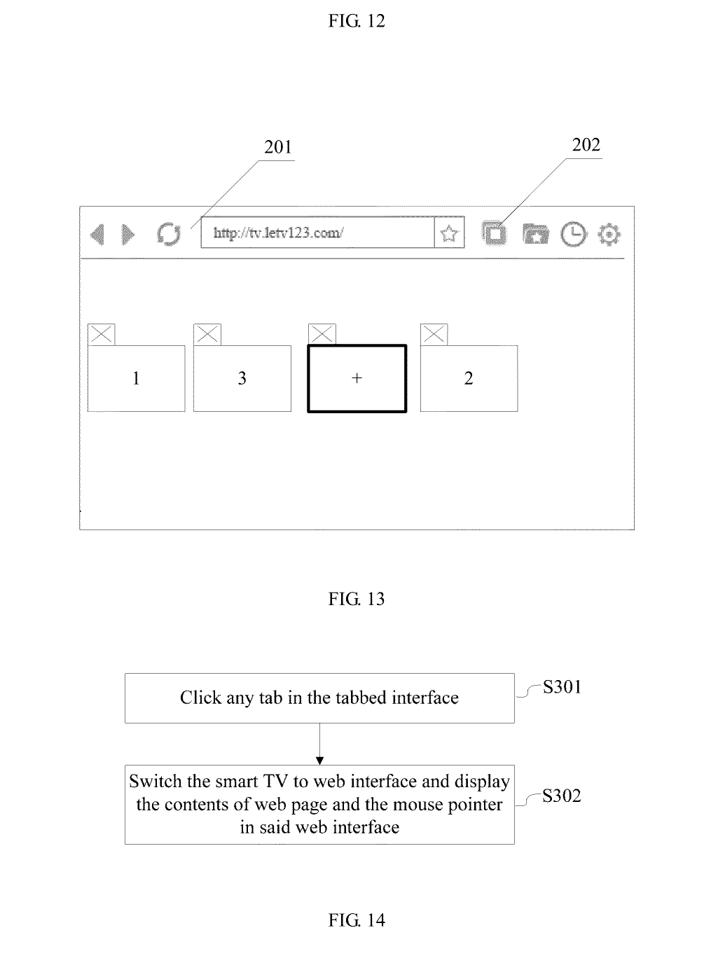

FIG. 12 shows another schematic diagram of the tabbed interface where the tab currently selected is 2 whose thumbnail, the name of the corresponding web page “Baidu” and the web site corresponding to said tab “www.baidu.com” are shown, other three tabs are not selected whose thumbnails are only shown. After the user click the key Up, the focus frame is moved up to the button “X” with close function. After the user clicks “Confirm”, the tab 2 is closed, there are total 3 tabs left in the tabbed interface which are 1, 3 and the newly added tab.

Step S205: the user presses the key Right to control the focus frame to move right to the newly added tab. Then clicks Confirm to open the main page preset in the smart television to add new tab.

FIG. 13 shows another schematic diagram of the tabbed interface where the tab currently selected is the one newly added. Click the key Confirm to open the main page preset in the smart television where the user can search any content and add new tab.

In this application scenarios, Step S201˜S202 is the process to switch to tabbed interface. The following steps S203˜S205 is the process to control the movement of the focus frame in the tabbed interface. In actual practice, the two processes are not bound together and either process of controlling the movement of the focus frame can be implemented separately and is not bound to one another. In other application scenarios, the user can move the focus frame as per the actual demand to conduct corresponding operation.

The specific flow chart of another application scenario is as shown in FIG. 14.

The switching in this application scenario mainly involves the switching from tabbed interface to web interface in the browser.

Step S301: clicking any tab in the tabbed interface,

The tabbed interface after the focus frame is moved is as shown in FIG. 11 where the one currently selected is 2 whose thumbnail, the name of corresponding web page and the corresponding web site are shown, other three tabs are not selected whose thumbnails are only shown.

Click the thumbnail of the tab 1 to generate the requesting information to request switching the current smart television interface to the web interface. As per the correspondence between the web interface and the preset operating mode, the operating mode matching the tabbed interface is acquired as air mouse mode.

Step S302: switching the smart television to the web interface and displaying the contents of web page and the mouse pointer in said web interface.

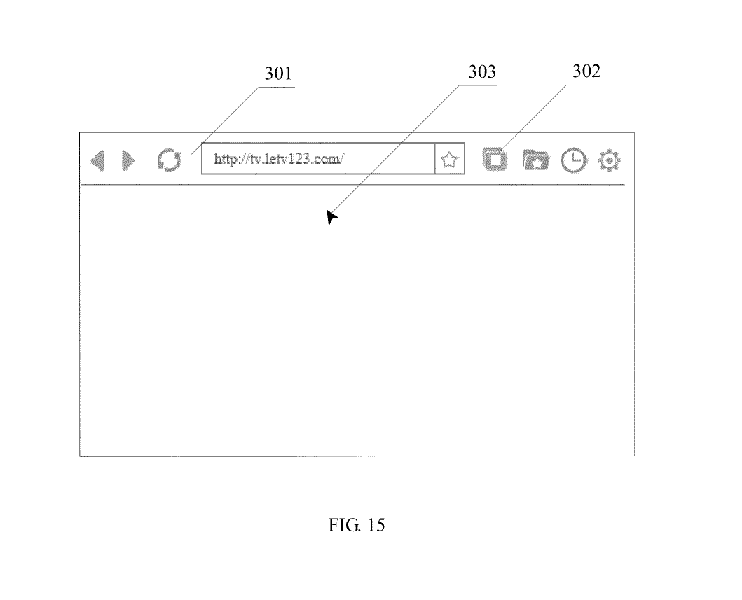

The web interface acquired from switching is as shown in FIG. 15 where there is a tab button 302 preset in the search bar 301 of the browser of a smart television and a mouse pointer 303 is displayed.

The above describes in details the method and instruction mode switching device based on a smart television interface provided according to the present disclosure. In this paper, the specific examples are used to describe the principle and the embodiments of the present disclosure. The description on the embodiments as above is used only to help understanding the methods and its core ideas of the present disclosure; meanwhile, ordinary technical personnel skilled in the art can accord to the idea of the present disclosure to modify the concrete embodiments and the application scope. In summary, the contents in the specification shall not be understood as any limit on the present disclosure.

1. An instruction mode switching method based on a smart television interface, characterized in that, the method comprises:
receiving a requesting information to switch the current smart television interface to a target interface,
analyzing said requesting information to obtain the target interface requested to switch and acquiring the operating mode matching said target interface as per the correspondence between said target interface and the preset operating mode,
switching the smart television to said target interface and executing the operation of said target interface by means of said operating mode.

2. The method according to claim 1, characterized in that: said correspondence between said target interface and the preset operating modes is:
if said target interface is a tabbed interface, said preset operating mode is a focus mode, said tabbed interface is an interface which comprises and displays at least one tab,
if said target interface is a web interface, said preset operating mode is an air mouse mode.

3. The method according to claim 1, characterized in that: said receiving a requesting information to switch the current smart television interface to a target interface comprises:
if said target interface is a tabbed interface, said tabbed interface is an interface generated through triggering a tab button preset in the search bar on the browser interface of said smart television,
when said tab button is triggered, the requesting information to switch the current smart television interface to said tab interface is received.

4. The method according to claim 1, characterized in that: said switching the smart television to said target interface and execute the operation of said target interface by means of said operating mode comprises:
when said target interface is a tabbed interface, the preset operating mode matching said tabbed interface is focus mode, said smart television interface is switched to said tabbed interface and the individual tab and the focus frame on said tabbed interface is displayed,
the command of switching to focus mode is generated and the mode-switching interface of remote control is called to send said command of switching to focus mode to the remote control so as to control said focus frame to move among said various tabs by said remote control and display the brief information of tabs.

5. The method according to claim 4, characterized in that the method further comprises:
when said focus frame is moved among said various tabs, said tab selected is dragged to the position of visual focus.

6. The method according to claim 4, characterized in that: if said tabbed interface is the interface generated through triggering the tab button preset in the search bar on the browser interface and said tab is the tab selected by the focus frame, the brief information of the tab displayed comprises the thumbnail of said tab, the name of web page corresponding to said tab and the web site corresponding to said tab,
if said tab is the tab selected by the focus frame, the brief information of the tab displayed comprises: the thumbnail of said tab.

7. The method according to claim 1, characterized in that: said switching the smart television to said target interface and execute the operation of said target interface by means of said operating mode comprises:
if said target interface is a web interface, the preset operating mode matching said web interface is air mouse mode, said smart television interface is switched to said web interface and the contents of a web page and the mouse pointer on said web interface is displayed,
the command of switching to air mouse mode is generated and the mode-switching interface of remote control is called to send said command of switching to air mouse mode to the remote control so as to control said mouse pointer to move by said remote control.

8. A smart television based on a smart television interface, characterized in that, the smart television comprises:
a memory having instructions stored thereon,
a processor configured to execute the instructions to perform operations, comprising:
receiving a requesting information to switch the current smart television interface to a target interface,
analyzing said requesting information to obtain the target interface requested to switch and acquire the operating mode matching said target interface as per the correspondence between said target interface and the preset operating mode,
switching the smart television to said target interface and execute the operation of said target interface by means of said operating mode.

9. The smart television according to claim 8, characterized in that: if said target interface is a tabbed interface, the preset operating mode matching said tabbed interface is focus mode, and the processor is further configured to perform:
switching said smart television interface to said tabbed interface,
generating a command of switching to focus mode,
calling the mode-switching interface of remote control to send said command of switching to focus mode to the remote control so as to control said focus frame to move among said various tabs by said remote control,
displaying various tabs and focus frame of said tabbed interface and the brief information of said tab.

10. The smart television according to claim 8, characterized in that: if said target interface is a web interface, the preset operating mode matching said tabbed interface is air mouse mode, and the processor is further configured to perform:
switching said smart television interface to said web interface,
generating a command of switching to air mouse mode,
calling the mode-switching interface of remote control to send said command of switching to air mouse mode to the remote control so as to control said mouse pointer to move by said remote control,
displaying the contents of web page and the mouse pointer of said web interface.

11. A non-transitory computer readable recording medium
having computer programs stored thereon that, when executed by one or more processors of a smart television, cause the smart television to perform:
receiving a requesting information to switch the current smart television interface to a target interface,
analyzing said requesting information to obtain the target interface requested to switch and acquiring the operating mode matching said target interface as per the correspondence between said target interface and the preset operating mode,
switching the smart television to said target interface and executing the operation of said target interface by means of said operating mode.

12. The method according to claim 2, characterized in that: said switching the smart television to said target interface and execute the operation of said target interface by means of said operating mode comprises:
when said target interface is a tabbed interface, the preset operating mode matching said tabbed interface is focus mode, said smart television interface is switched to said tabbed interface and the individual tab and the focus frame on said tabbed interface is displayed,
the command of switching to focus mode is generated and the mode-switching interface of remote control is called to send said command of switching to focus mode to the remote control so as to control said focus frame to move among said various tabs by said remote control and display the brief information of tabs.

13. The method according to claim 3, characterized in that: said switching the smart television to said target interface and execute the operation of said target interface by means of said operating mode comprises:
when said target interface is a tabbed interface, the preset operating mode matching said tabbed interface is focus mode, said smart television interface is switched to said tabbed interface and the individual tab and the focus frame on said tabbed interface is displayed,
the command of switching to focus mode is generated and the mode-switching interface of remote control is called to send said command of switching to focus mode to the remote control so as to control said focus frame to move among said various tabs by said remote control and display the brief information of tabs.

14. The method according to claim 2, characterized in that: said switching the smart television to said target interface and execute the operation of said target interface by means of said operating mode comprises:
if said target interface is a web interface, the preset operating mode matching said web interface is air mouse mode, said smart television interface is switched to said web interface and the contents of a web page and the mouse pointer on said web interface is displayed,
the command of switching to air mouse mode is generated and the mode-switching interface of remote control is called to send said command of switching to air mouse mode to the remote control so as to control said mouse pointer to move by said remote control.

15. The method according to claim 3, characterized in that: said switching the smart television to said target interface and execute the operation of said target interface by means of said operating mode comprises:
if said target interface is a web interface, the preset operating mode matching said web interface is air mouse mode, said smart television interface is switched to said web interface and the contents of a web page and the mouse pointer on said web interface is displayed,
the command of switching to air mouse mode is generated and the mode-switching interface of remote control is called to send said command of switching to air mouse mode to the remote control so as to control said mouse pointer to move by said remote control.
